(19) United States
(12) Patent Application Publication
(10) Pub. No.: US 2003/0216946 A1
(43) Pub. Date: Nov. 20, 2003

(54) Methods and system for repricing healthcare claims

(76) Inventor: Stephen P. Ferraro, Double Oak, TX (US)

Correspondence Address: Arthur I. Navarro, Godwin Gruber, P.C., Renaissance Tower, Suite 1700, 1201 Elm Street, Dallas, TX, 75270, US

(21) Appl. No.: 10/146,861

(22) Filed: May 16, 2002

(51) Int. Cl. G06F 17/60

(52) U.S. Cl. 705/4

(57) ABSTRACT

A medical claims repricing system (200) and method (100) of repricing claims from multiple PPO networks and from both primary and secondary healthcare providers. The system (200) comprises a terminal (212) for accepting and processing medical claims data and processing software (230) operably associated with the terminal (212) and adapted for receiving the data in a core claim record (210) and automatically repricing a medical claim by comparing and validating the claim against a plurality of client, plan and group records (220).

### TECHNICAL FIELD

The present invention relates to the processing of healthcare based claims and, more specifically, to the discounting of healthcare claims based on predetermined contractual amounts between provider organizations and physicians. More specifically, the present invention relates to an automated system and related methods for repricing healthcare claims from a number of Preferred Provider Organization (PPO) networks based on claim details, Common Procedure Terminology (CPT) codes, physician and facility data, and preestablished contract details.

### BACKGROUND OF THE INVENTION

The phenomenal growth in managed care has resulted in widespread change across the healthcare industry affecting the insured, insurance companies and healthcare providers. An important entity in the managed care practice is the PPO. In essence, a PPO recruits physicians or professional service providers and facilities or institutional providers to offer services at a discounted rate in return for what is called “steerage.” With steerage, a directory is produced that lists a doctor's name, his or her address and telephone number and any specialties. An insurance company, in turn, encourages use of PPO physician members with incentives that limit the out-of-pocket cost of an insured for using a member physician.

Thus, steerage provides a benefit that is enhanced over a standard benefit by utilizing doctors, hospitals and facilities in a PPO directory. The healthcare provider, in turn, has a contract with the PPO that discount rates for certain procedures provided to insureds. Most often, CPT codes are used to designate the type of procedure performed. The CPT codes can be cross-referenced to a table maintained by the PPO in order to determine what charge is allowed for a particular procedure. Repricing is the act of discounting each procedure in a claim to the contractual amount agreed between the PPO and the physician based on, for example, the CPT code of a procedure. The PPO provides tabular data to a repricing agent, such as Third Party Administrator (TPA) or insurance company, and the agent determines the discounted values based on a geographic fee schedule and the CPT codes. Often, the repricing agent utilizes special software to facilitate the repricing process.

The repricing process, however, has been complicated by the emergence of numerous regional and large PPO networks as well as lack of standardization across the industry in general. While a particular PPO network may have its own methodology and/or repricing software, another PPO network may use different software and a different set of contracts and fee schedules with their physician and facility providers. Thus, the ABC PPO network, and the XYZ PPO network, may use completely different data in a completely different format in order to reprice claims. Moreover, the contracts they have with their healthcare providers may be completely different, making determination of the CPT procedure and the discounted amount applied to particular procedures difficult to determine. From the standpoint of the repricing agent, it may be difficult or even impossible to manage all the details of the different PPO networks in order to achieve efficient and accurate repricing.

Moreover, the repricing practice is further complicated by the fact that repricing agents are often discounting claims for a number of PPO networks. As stated above, since PPO networks differ in the fee arrangement schedules and structures used with their healthcare providers, the agent may be unable to determine the appropriate discount rate for the corresponding claim. For example, an insurance company may have contracts or agreements with 50 or 60 different PPO networks, all of which may need to have their claims repriced. For accurate repricing, the agent would have to possess each piece of software used by each PPO network and be staffed and trained in the use of the various software applications used by each network. Thus prior art repricing systems do not provide an easy way of dealing with multiple PPO networks and ensuring that a uniform repricing strategy or system is applied.

Another difficulty with repricing relates to the processing of out-of-network claims. In a primary network situation, the insurance company has a contract with a specific PPO network and an insured is encouraged, thru discounts and high coverage limits, to utilize doctors in that network but is also allowed to use doctors out-of-network or within a “secondary” network. In general, visits to physicians not within the insured's primary PPO network subjects the insured to a higher payment under his or her insurance policy. The repricing agent, however, must still reprice the claim based on a service provider belonging to a network outside the insurance company's area and there is no readily available means of repricing claims in secondary situations.

Thus, a means for efficiently and accurately repricing healthcare claims is needed. More specifically, a means of allowing the repricing agent to reprice claims from multiple PPO networks, and in both primary and secondary networks, would provide numerous advantages.

### SUMMARY OF THE INVENTION

The present invention provides methods and systems of repricing healthcare claims by greatly enhancing the efficiency of current repricing systems or policies from the standpoint of the repricing agent. Specifically, the present invention provides for automatic selection of the appropriate PPO network based on eligibility information and network details. Moreover, the present invention provides a means of repricing out-of-network claims by establishing a batting order of PPO networks to be used in secondary situations.

Therefore, according to one embodiment of the present invention, disclosed is a medical claims repricing system. The system comprises a terminal for entering and processing medical claims data and processing software operably associated with the terminal and adapted for receiving the medical claims data and automatically repricing a medical claim by comparing and validating the claim against a plurality of client, plan and group records. The system may further comprise storage means within the terminal and one or more data bases contained within the storage means for storing the client, plan and group records. According to one embodiment, the system is further adapted to reprice a medical claim based on whether a claim is made within a primary or secondary network. In this regard, the system comprises a secondary network database storing a plurality of secondary network identifiers arranged in a predetermined batting order. Thus, the processing software is further adapted to reprice a medical claim made within a secondary network by checking the predetermined batting order.

According to one aspect, the one or more databases comprise a set of standardized medical procedures which are identified using Common Procedure Terminology (CPT) codes. In this way, the processing software may cross-reference a medical claim against the CPT codes and against a physician associated with the medical claim to determine a charge for the procedure or procedures specified in a medical claim.

Also disclosed is a method of repricing medical related claims submitted by insured claimants for services performed by any one of a plurality of service providers when the service providers are associated with one or more service provider networks. The method comprises the step of medical claim data for a specified medical claim being entered into a terminal adapted for receiving, storing and analyzing the medical claim data. The method also comprises a step of processing software within the terminal automatically repricing the medical claim by comparing and validating the medical claim data against a plurality of client, plan and group records, wherein the repricing of a particular medical claim is done by cross-referencing any medical procedures performed by a physician against a plurality of common procedure terminology codes (CPT codes) and correlating the procedures against contract rules governing the charge for a procedure by a physician in a corresponding network of service providers.

According to one embodiment, the method may further comprise the step of automatically verifying that an insured is covered by a contract associated with one of the service providers in the network.

According to another embodiment, the method comprises a step of determining if a medical claim is covered by a service provider in a primary or secondary network. Furthermore, the method can comprise a step of manually verifying a claim if it is not covered by a service providers in either a primary or secondary network.

According to another aspect of the invention, the method further comprises the step of repricing the medical claim by checking a list of secondary networks, the list arranged according to a predetermined batting order.

Advantages of the invention are numerous and include the efficient and cost effective repricing of medical claims from the standpoint of the third-party administrator, insurance company or other repricing agent. The system of the present invention provides a uniform format for entering medical claims data and validating it against a plurality of client, plan, and group records in order to reprice a claim. Therefore, the system overcomes the disadvantages of the numerous prior art repricing systems which, for the repricing agent, are difficult to use and manage. Moreover, the present invention provides the added advantage of allowing the repricing of claims related to out-of-network physician service providers.

### BRIEF DESCRIPTION OF THE DRAWINGS

The invention, including its specific embodiments and advantages, will be understood from consideration of the following detailed descriptions taken in conjunction with the drawings, of which:

FIGS. 1-3 are process flow diagrams illustrating methods of repricing a medical claim according to the invention;

FIG. 4 is a generalized block diagram of a repricing system according to the invention;

FIG. 5 illustrates the interrelationship between the various client, plan and group records utilized by a repricing system in order to reprice medical claims;

FIG. 6 shows the interrelationship between the various functions provided by the medical claims repricing system of the present invention;

FIG. 7 illustrates a list of secondary networks arranged according to a predetermined batting order;

FIG. 8 illustrates a physician look-up screen that can be used for organizing physician service providers;

FIG. 9 illustrates a facility look-up screen;

FIG. 10 illustrates a physician claim screen;

FIG. 11 illustrates a record screen for a physician with access to contract details; and

FIG. 12 illustrates the contract details of the screen shot of FIG. 11.

References in the detailed description correspond to like references in the figures unless otherwise notes.

### DETAILS DESCRIPTION OF PREFERRED EMBODIMENTS

The present invention provides a system and related methods of repricing (i.e. discounting) healthcare insurance claims in order to provide a healthcare provider organization an indication of the appropriate amount to be charged for a claim based on a pre-existing contract between a PPO network and a physician. The invention utilizes a plurality of client, plan and group records in order to look up procedures according to CPT codes and cross-reference them to established fee schedules. By providing a uniform interface and method of entering, organizing and validating medical claims data, the invention overcomes the disadvantages of prior art repricing systems which are varied in format and structure and are difficult to use for efficient and accurate repricing. Moreover, the present invention provides a way of repricing claims made through secondary networks by utilizing a predetermined batting order of secondary network providers for out-of-network claims.

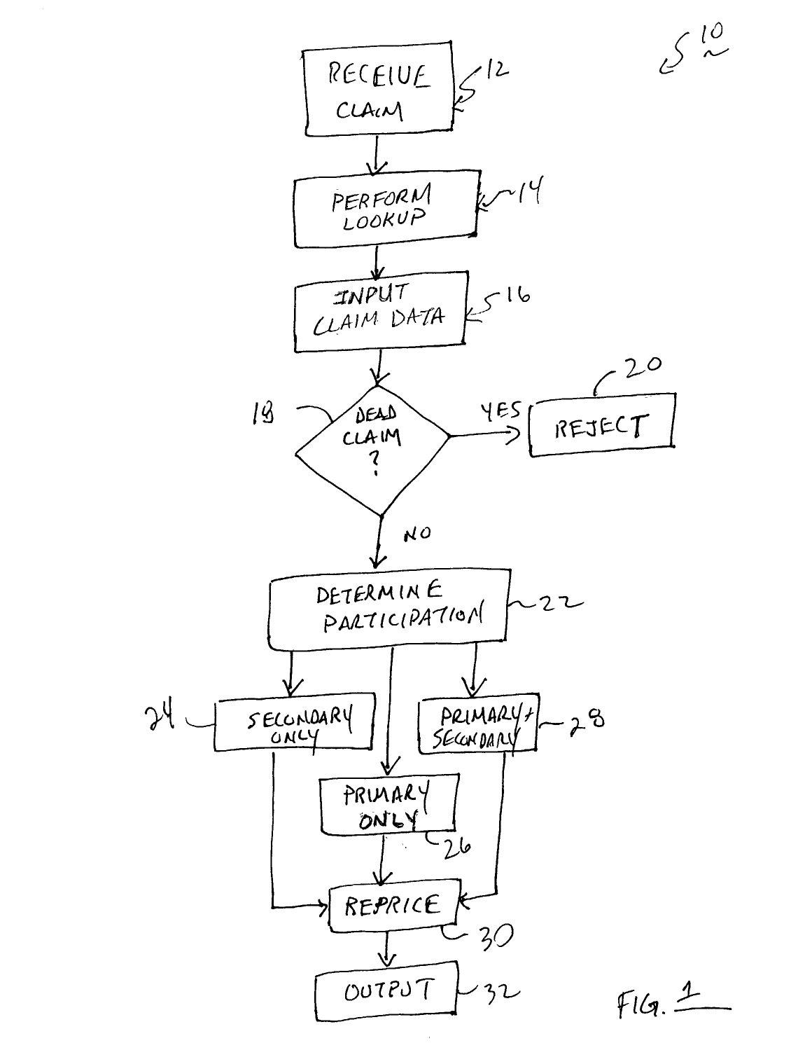

With reference now to the figures, and particularly to FIG. 1, therein is shown a process flow diagram of a medical claims repricing method according to the invention. The process, denoted generally as 10, involves the user of the system receiving a claim from, for example, a third-party administrator, insurance company or other healthcare related entity, step 12. In particular, step 12 involves receiving the medical claims data, such as the patient's identity and/or social security number or other identifying information, the physician's unique identification number, such as, for example, his or her tax id number, the group or PPO network the physician belongs to and an indication of the procedures performed by the physician service provider. In this regard, the procedures can be identified using common procedure terminology codes (CPT codes) which are well known in the medical industry.

Next, the process performs a lookup, step 14, wherein a cross-reference is made between the provider number and the fee schedule to use for that provider and the corresponding PPO network. If the contract file for the physician and PPO network information cannot be found, then process flow is directed to step 20 wherein the claim is rejected. Otherwise, following the decision at step 18, process flow is directed to step 22, wherein a determination is made if the claim was made in a secondary or primary network.

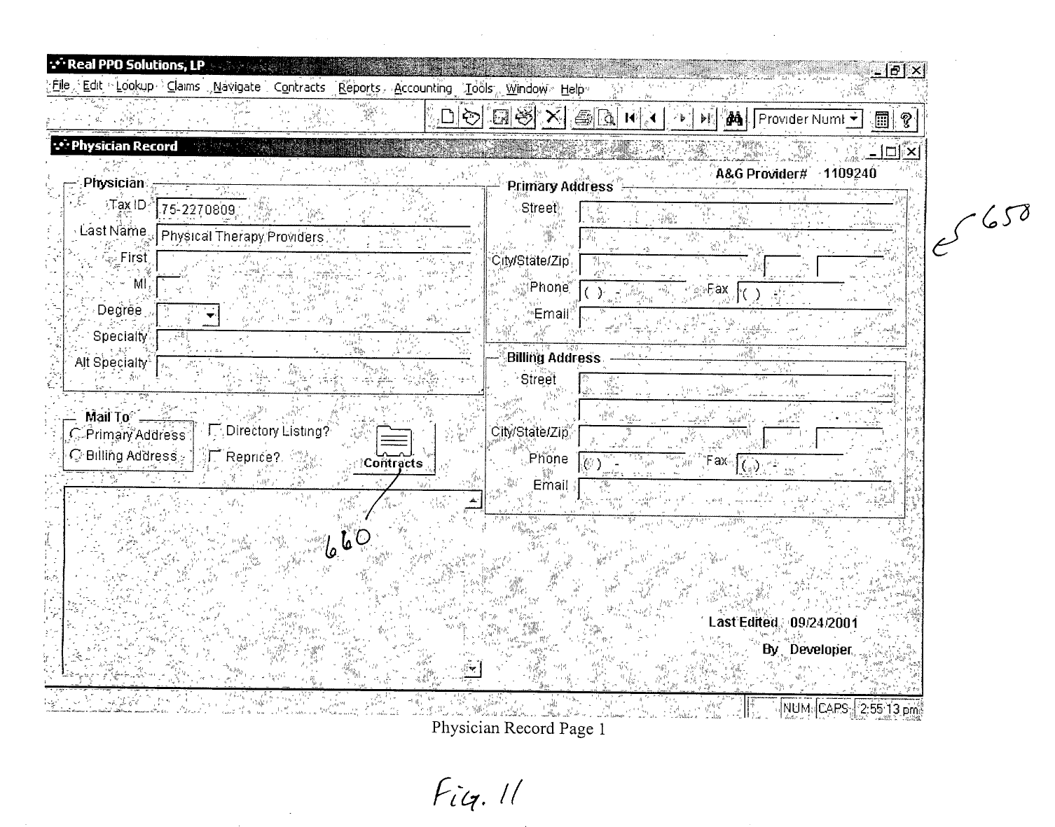

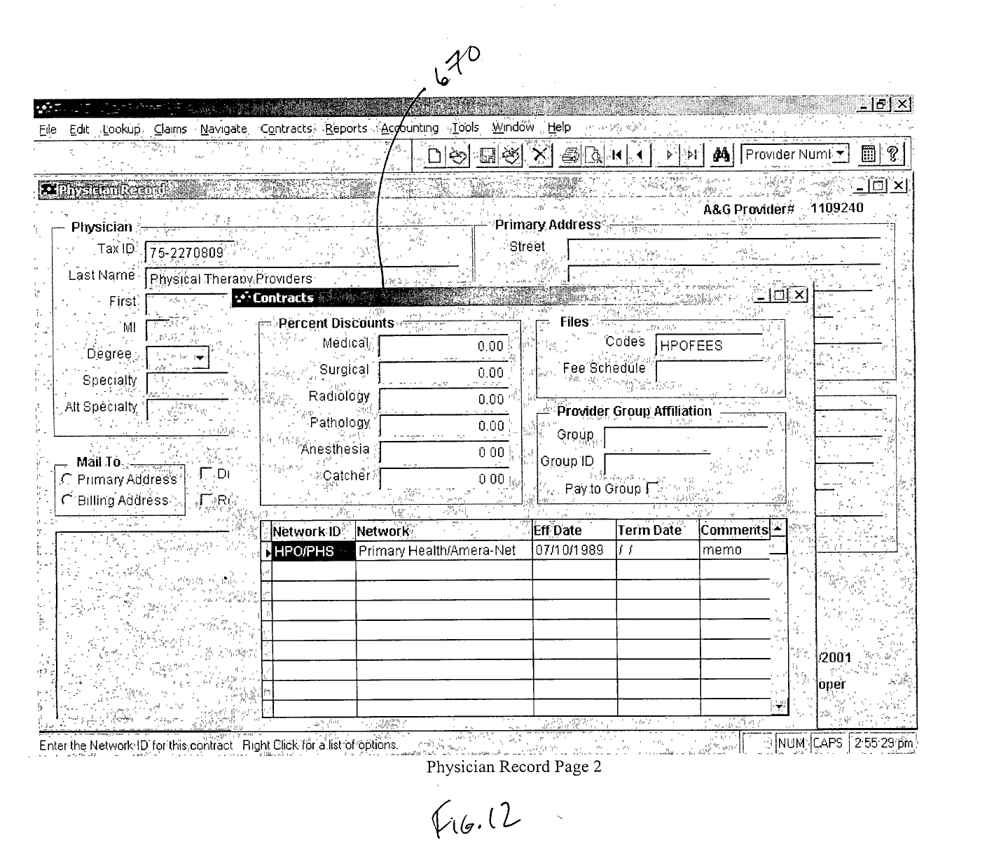

Next, process flow is directed to step 16 wherein the claim data is entered into a terminal adapted to perform the repricing functions as herein described. More particularly, the terminal contains repricing software which, as described below, works in conjunction with the terminal in order to take the medical claim data and reprice it to ensure it is discounted according to predetermined contractual amounts. In particular, and as described below in reference to FIGS. 11 and 12, the system includes a contract file for each physician and facility service provider that dictates the terms and amounts to be charged by the service provider as part of membership in a particular PPO network.

According to various embodiments of the repricing methodology of the present invention, multiple repricing strategies can be employed by the repricing agent as illustrated in blocks 24, 26 and 28. In secondary block 24, a determination is made whether the insured has placed a claim for a service provider not within a primary network of the insurance policy covering the insured. In contrast, block 28 means that a determination has been made that the insured has placed a claim covered by a physician within the primary network of the insurance policy. Moreover, since the system of the present invention is beneficial to both third-party administrators and insurance companies administering insurance claims, each of these parties can specify that repricing be restricted to primary claims only as indicated in block 26. Regardless of the repricing strategy employed, eventually the insurance claim is repriced, step 30, and the discount information is output, step 32.

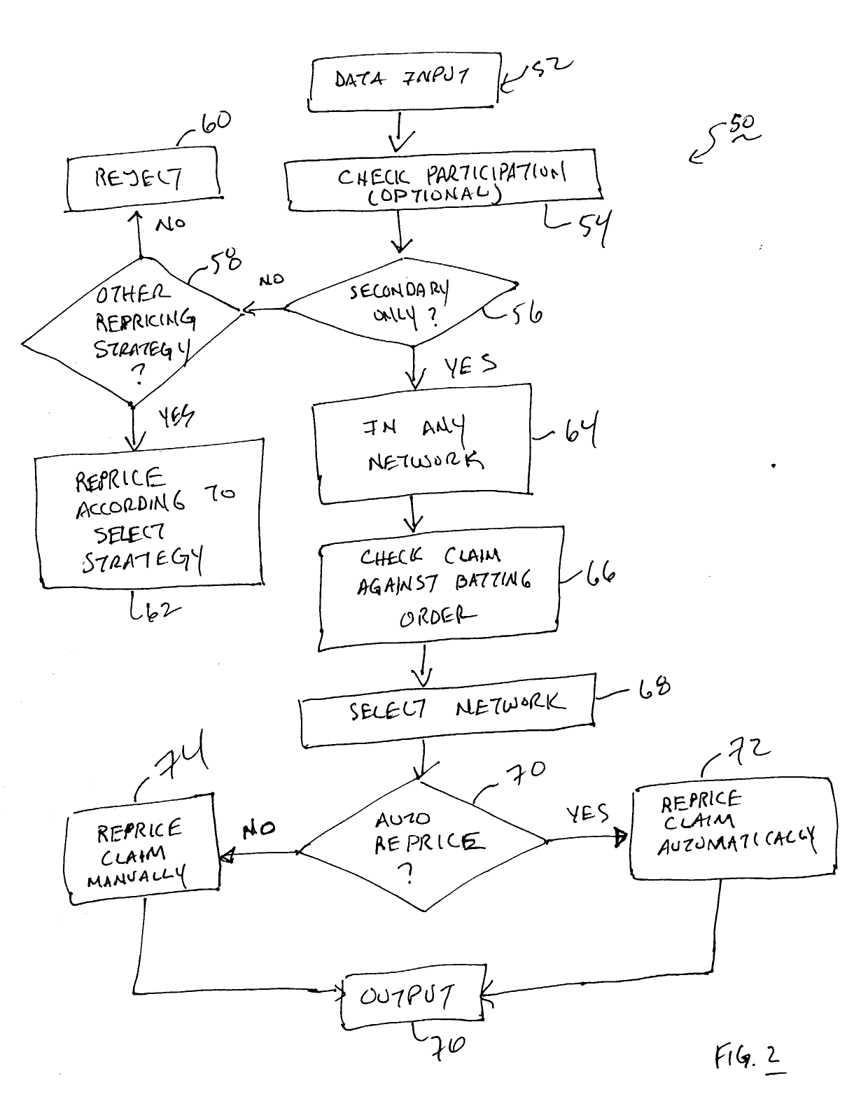

With reference now to FIG. 2, therein is shown a more detailed process flow diagram for the method of secondary network repricing according to the invention. The process of FIG. 2, denoted generally as 50, begins where the medical claims data is input, step 52, and the claim is verified for participation in either a primary, primary only, or secondary repricing strategy, step 54. Step 54 can be optional as various embodiments of a repricing methodology may be employed such that participation is predetermined based on preferences of the repricing agent. In this regard, a determination is made if the claim is secondary only at decision block 56, and if not, whether another repricing strategy should be utilized at decision block 58. If no repricing strategy is involved, the claim is rejected at step 60. Otherwise the claim is repriced according to another strategy, step 62.

Returning back to decision block 56, the claim is checked against a database of secondary networks in order to determine whether or not a network covering the claim exists, step 64. If so, the claim is validated against a batting order of secondary networks, step 66, as explained in more detail below. Essentially, batting order refers to an arrangement or list of secondary network providers ordered according to a predetermined scheme within a geographic region that dictates selection of a particular secondary network within the region where a claim is made. Thus, for secondary repricing a claim is checked against the batting order and the first secondary provider within a geographic region is selected unless other conditions require that the second secondary network in the list be chosen. The list can be maintained by the operator or user of the repricing system, and the order in which secondary networks are listed manipulated to suit the user's needs based on pre-determined criteria.

Next, process flow is directed to step 68 wherein a secondary network is selected from the batting order list prior to the claim being repriced. As shown at decision block 70, a determination is made as to whether the claim can be automatically repriced by the software of the repricing system and, if so, process flow is directed to step 72 wherein the software repricing system of the present invention automatically reprices the claim. If the claim cannot be automatically repriced, then process flow is directed to 74 where an operator of the repricing system looks at the claim data and manually reprices the claim. From steps 72 and 74, repriced claims are output, step 76, and an indication of the discount applied to each procedure of an insurance claim is provided.

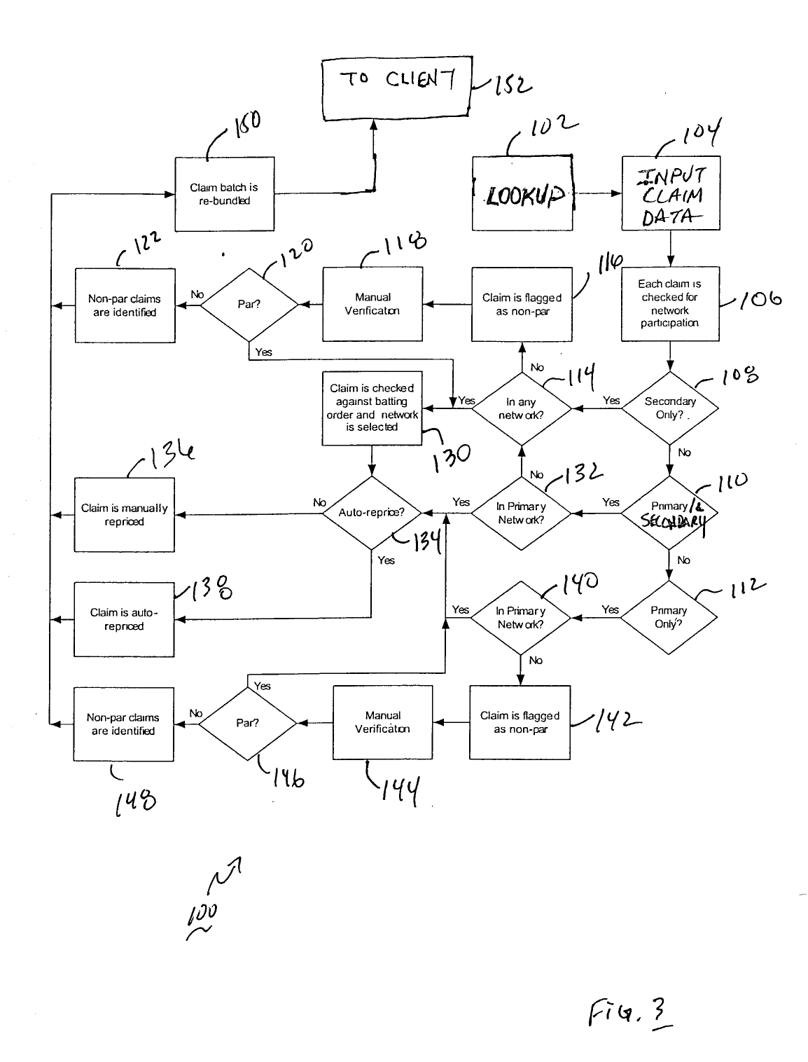

Thus, the present invention provides a method of repricing claims placed in secondary networks not covered by an insured's primary network under his or her insurance policy. This provides numerous advantages over the prior art as no readily available way of repricing secondary claims automatically was, until the present invention, known. Having described the repricing method and secondary network treatment in general, the process as a whole can be understood by reference to FIG. 3.

The entire process, denoted generally as 100, begins when a claim lookup function is performed, step 102, in order to determine whether the group and physician records corresponding to a given medical claim exist in the system. If so, specific medical claim data for the claim is input into the system, step 104. Next, at step 106, the claim is checked for network participation, meaning that a determination is made on the desired repricing strategy, such as primary, primary only, or secondary. These steps are indicated by decision blocks 108, 1 10 and 112, respectively.

The invention contemplates various embodiments of a repricing system and methods of repricing healthcare claims to provide a flexible tool for efficient and accurate repricing by a repricing agent. In this regard, the various embodiments provide the repricing agent with several repricing options. One option relates solely to the repricing of claims made outside the insureds' primary network or secondary network claims. This option is available to repricing agents that, for example, are able to reprice primary, but lack the means of repricing secondary, network claims or doing so would be inefficient from the standpoint of the organization.

Alternatively, the invention provides the ability to reprice both primary and secondary network claims thereby providing a complete repricing solution. This option may be attractive to repricing agents who handle claims from multiple provider networks or who lack a uniform repricing system for all provider claims. As explained below in more detail, a “batting” order of secondary networks is used by the system and methods of the invention to select an appropriate secondary network for repricing of secondary network claims. If the option to reprice both primary and secondary network claims is chosen, the insureds' primary network is moved to the top of the batting order ensuring that, where possible, the insureds' primary network is chosen first.

Finally, the repricing agent may elect to reprice only primary claims, meaning the system will reject claims placed in secondary network. Thus, the invention allows the repricing agent the option to select a desired repricing strategy.

According to one embodiment, secondary repricing is the only strategy desired as determined at decision block 108, process flow is directed to decision block 114, wherein it is determined if the claim can be related to any network within the list of secondary networks. If no network is found by the system automatically, the claim is flagged as non-par, step 116, and an attempt is made at manual verification, step 118, to verify whether or not the claim is par at decision block 120. A par claim is one that includes an appropriate insured identifier, group plan and physician provider information. In addition, a par claim includes an appropriate CPT code for the procedures performed so that verification against the physician group and contract details can be accomplished. If manual verification determines that the claim is par, process flow is directed to step 130, wherein the claim is checked against a batting order of secondary networks as explained above. Otherwise a claim is verified to be non-par at step 122.

According to another embodiment, the TPA or insurance company may request both primary and secondary repricing and, if so, a determination is made at decision block 110. Next, process flow is directed to decision block 132 wherein the claim is checked against a list of primary networks covered by the insured's insurance policy. Based on the services rendered by a physician within a primary network, process flow is directed to decision block 134 to determine if automatic repricing of the claim is available. If so, process flow is directed to step 138 where the claim is automatically repriced by the repricing system. Otherwise, the claim is manually repriced by the operator of the repricing system at step 136.

Going back to decision block 132, if a claim is not matched against a primary network, then process flow is directed at step 114 wherein a determination is made if the claim is related to any network in the system. This provides a way of implementing the primary or secondary repricing strategy flowing from decision block 110.

In this way, the present invention provides the fundamental methodology for a system of repricing medical claims whether the service was provided by a physician or facility in a primary network (PPO network) or a secondary network. Since healthcare insurance companies provide different discounts and percentages of coverage based on whether it is a primary or secondary situation, the present invention provides an efficient and effective way of repricing both primary and secondary claims.

With reference still to FIG. 3, and in particular to decision block 112, a determination is made if the TPA or insurance company has requested primary only repricing and, if so, process flow is directed to decision block 140. Since a secondary repricing strategy is not involved, a decision is made if the claim is related to a primary network and, if not, process flow is directed to step 142, wherein the claim is flagged as non-par. Otherwise, if a match between the claim and a covered primary network is made, process is directed to block 134, wherein a determination is made if the claim can be automatically repriced.

Back at step 142, in order to verify the functionality of the system and the accuracy of the medical claim data input into the system, manual verification can be performed, step 144, by the operator. If a claim is verified as being non-par at decision block 146, then a claim is identified as non-par, step 148. All claims from the TPA or insurance company are bundled, meaning that the discounted rate applied to each procedure for each physician service provider in either the primary or secondary network as indicated by the repricing strategy, is output in a report which can be transmitted to the client at step 152. Likewise, if manual verification, step 144, determines that the claim is par from decision block 146, then process flow is directed to decision block 134, and the process continues as previously described.

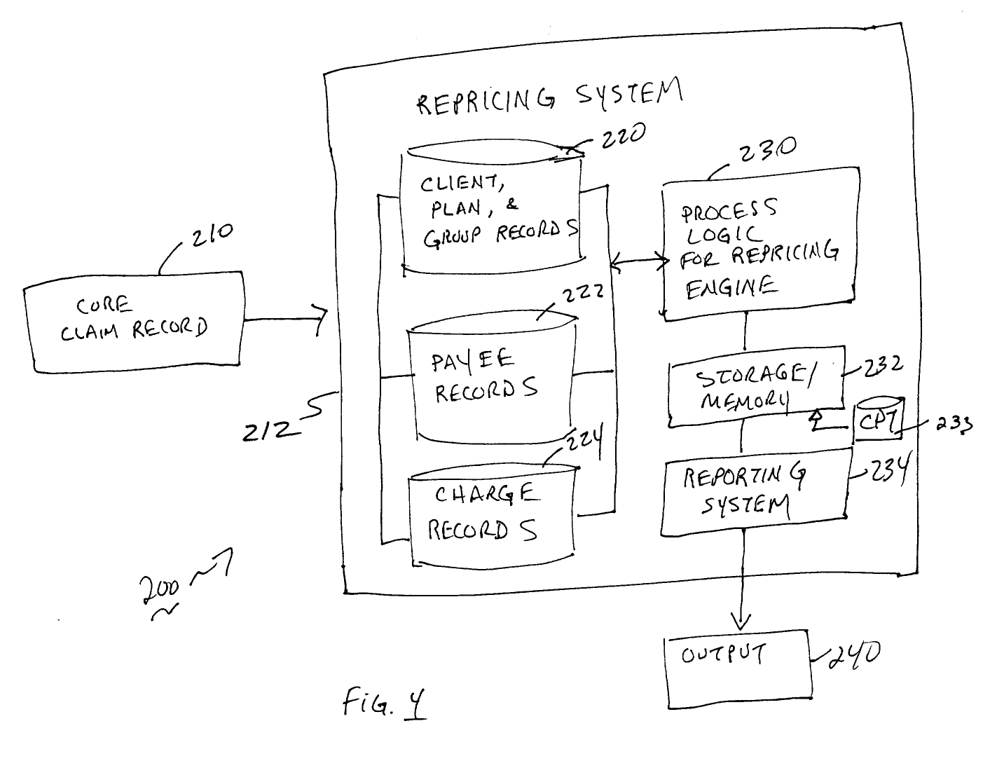

With reference to FIG. 4, a repricing system according to the invention is shown and denoted generally as 200. In general, repricing system 200 is adapted to accept a core claim record 210 via a terminal (212). The core claim record 210 includes all the medical claim information for a patient, including the patient's group plan, the physician service provider information and description of the procedures performed under the claim, as well as a unique identifier for the insured. It should be understood, however, that other claim data may be utilized by the repricing system 200 in order to reprice a claim as herein described.

As shown, the terminal 212 of the repricing system 200 includes a plurality of client, plan and group records 220. A client record is, by definition, an indicator of the customer, such as a third-party administrator (TPA) or an insurance company who is requesting repricing from the repricing agent operating the system 200. A plan record includes the detailed information of what a plan for a particular insured provides. The group's records includes a set of rules that dictate what an insured belongs to and what the insured is allowed to take advantage of by participation in a particular insurance plan. For example, an employee may be part of a group policy for a particular company, or he may be part of multiple plans that comprise an association that allows him to participate in a particular plan. Other arrangements are possible and would be indicated in the group records of the client, plan and group records database 220.

The repricing system also includes payee records 222 which include information about all the various parties that get paid following application of a particular repricing strategy. Likewise, a database of charge records 224 is provided and used by the repricing system 200 in order to determine who gets charged for the services provided by the repricing agent utilizing the repricing system 200.

Another component of the repricing system 200 is the processing software 230 that includes the programs and software, in the form of logic and software instructions, for operating the repricing system 200 and causing it to perform the repricing methodologies described above with respect to FIGS. 1-3. The implementation of particular processing software to accomplish such functions is left to the discretion of one of ordinary skill in the art who, upon reference to this disclosure, should be able to implement such software in a repricing system according to the invention. Likewise, a storage and memory subsystem 232 is provided for storing the various pieces of information used to perform the repricing functions in connection with the database 220, 222 and 224, and for use by the processing software 230. This would include access to a CPT codes database 233 which would contain the various codes used to identify procedures performed by physician and facility healthcare providers. Finally, a reporting system 234 is provided such that a set of reporting functions and reports can be implemented and produced by the system 200 to generate an output 240.

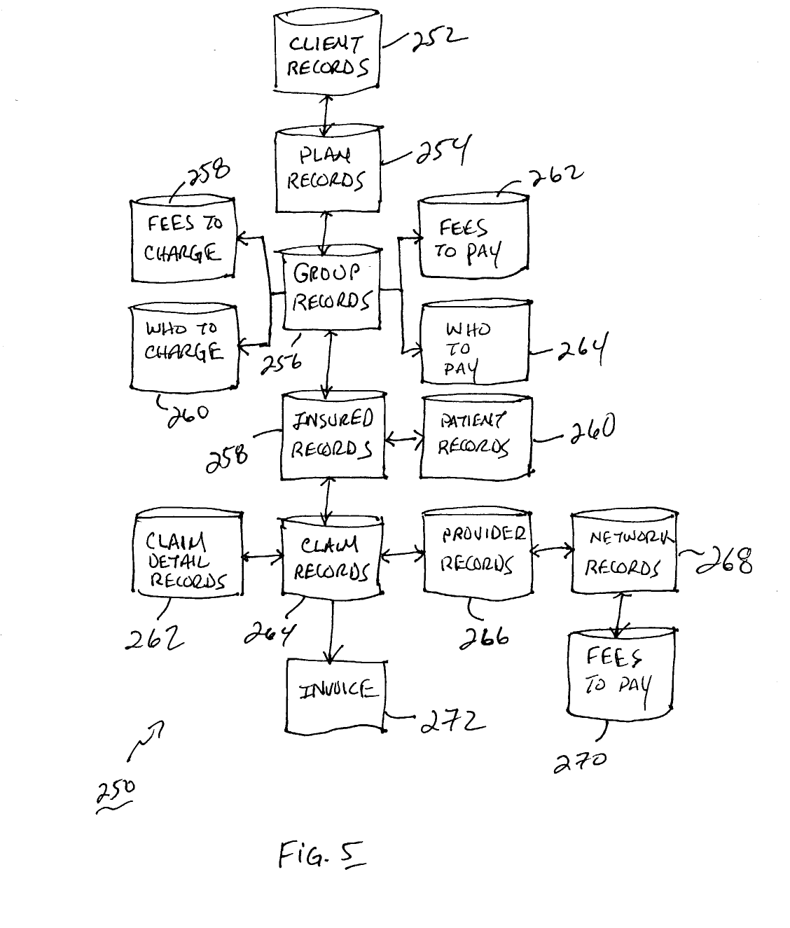

With reference now to FIG. 5, therein is shown a detailed overview of the database structure for use by a repricing system, such as repricing system 200, according to the invention. The database structure, denoted generally as 250, includes client records 252, wherein detailed information about the clients for which repricing is to be performed is maintained. Such information can include basic contact information, such as the address, name of the TPA or insurance company and specific contact. Of course, the claim records 252 can include other types of data according to the needs of the repricing system operator. Correlated to the client records 252 are the plan records 254, which include the details of the insurance plan supported by the PPO networks to which the physician service providers belong. This would include details about percentage paids and other particulars related to a particular insurance policy.

As shown, a database of group records 256 uses the information in the client's record database 252 and plan records database 254 in order to determine what fees to charge 258, who to charge 260, what fees to pay 262, and who to pay 264. The database of group records 256 also uses a database of insured records 258 in order to determine the various fees associated with repricing of a medical claim. A database of patient records 260 is maintained such that the repricing system 200 can compile a history for the patient including the types of procedures performed and the amount of payouts made on his behalf.

The database architecture 250 includes detailed records of claims 262 including a claims records database 264 that provides a claims history for all claims made by a given insured. The claims records database 264 is particularly useful in the processing of secondary network claims such that if a change is made to the batting order, subsequent claims by the same insured will be repriced using the same secondary network as was assigned for a prior claim. Thus, the claims history of the claims history database 264 takes precedence over the batting order. In this regard, the provider records 266 include physician or healthcare provider information for providers in both primary and secondary networks while the network records database 268 includes information about the primary and secondary networks to which individual providers belong. A database of fees to pay 270 includes all the information payable by network provider organizations as well as a history of fees paid by such organizations as determined by the network records database 268. Finally, all invoices generated for clients of the repricing system are stored in an invoice database 272.

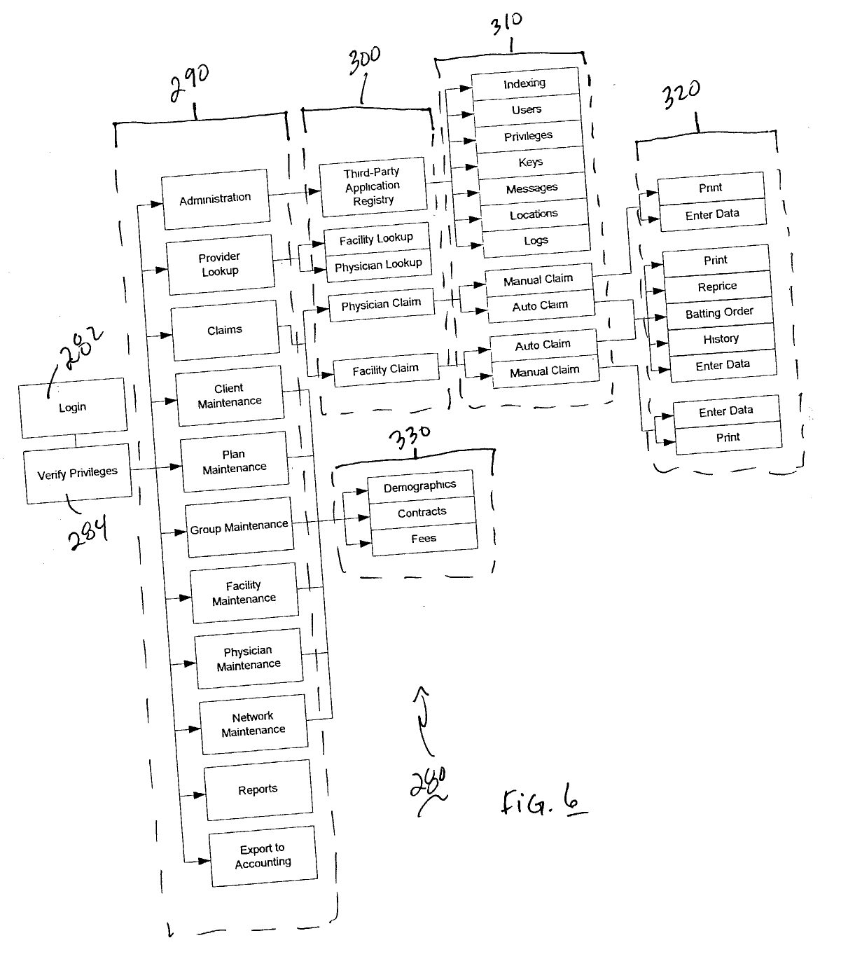

With reference now to FIG. 6, therein is shown a block diagram of the various functional components that a repricing system, according to one embodiment of the invention, may support. The repricing system 280 includes a login function 282 which can take the form of a graphical user interface presented to a user or operator of the repricing system such as, for example, a screen with user and password entries. The user and password entries can be verified at verify function 284 which, grants or denies privileges, to control access to top level functions 290. As shown, functions 290 include administration, provider lookup, claims, client maintenance, plan maintenance, group maintenance, facility maintenance, physician maintenance, network maintenance, reports and export to accounting. It should be understood, however, that more or less functions may be included in any repricing system that functions substantially as described herein.

A second level of functions 300 and 330 allow maintenance of the administration, provider lookup, and claim functions of block 290. These include third-party application registry, facility lookup, physician lookup, physician claim, facility claim, demographics, contracts and fees. The functions in block 300 lead to a third level of functionality in block 310 which include, among other features, indexing users' privileges keys, messages, locations, logs, as well as manual and auto-claim features for both the physician and facility claim functions of block 300. Finally, a fourth level of functionality for a repricing system according to the invention is contained in block 320. The functions in block 320 allow further manipulation of the manual and auto-claim functions in block 310 including the printing and entering of data, the manipulation of batting order, and historical information for both physicians and facilities.

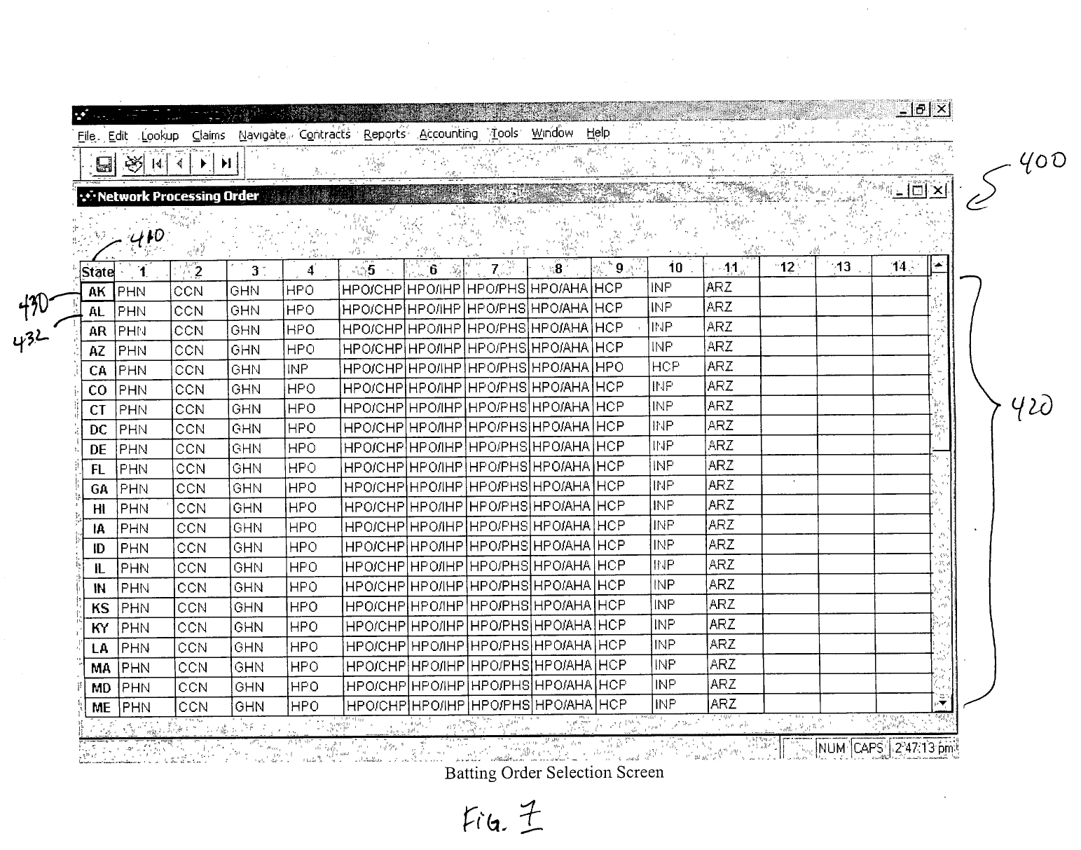

As mentioned above, a significant problem with the repricing insurance claims are the repricing of claims made outside an insurance company's primary network (PPO network). As such, the present deals with this problem by providing a system that allows the repricing of medical insurance claims according to a predetermined batting order of secondary networks arranged according to the preference of the repricing system operator and geographic location. With reference now to FIG. 7, therein is shown the screen interface to a batting order selection screen 400 which can support repricing of secondary claim situations. As shown, the selection screen 400 includes a state designation column 410 which defines a geographic region for the preferences indicated along rows 420. Taking the upper left-hand example 430 for the state of Alaska (AK), the secondary networks are listed from left to right in columns 1-14 according to order of preference. Likewise, row 432 indicates the batting order of secondary networks for the state of Alabama (AL).

The batting order selection screen 480 can be edited and manipulated according to a predetermined strategy of the repricing system operator to indicate preferences prior to repricing. For example, the batting order can be based on the geographic area in which the physician service provider is located and the amount of discounts received by the network to which the physician belongs. The selection of a particular secondary network would be determined during a lookup step wherein by the repricing system chooses the first listed secondary network, as shown in column 1 of the selection screen 400, unless some default exist or other condition mandates selection of the next in line secondary network in the batting order. As mentioned above, one default can be the claim history of a particular insured wherein a secondary network previously chosen for an insured would be the default assigned to subsequent claims by the same insured even if the batting order changed. Other criteria can be determined by the repricing operator to dictate the selection of the secondary networks contained in the selection screen.

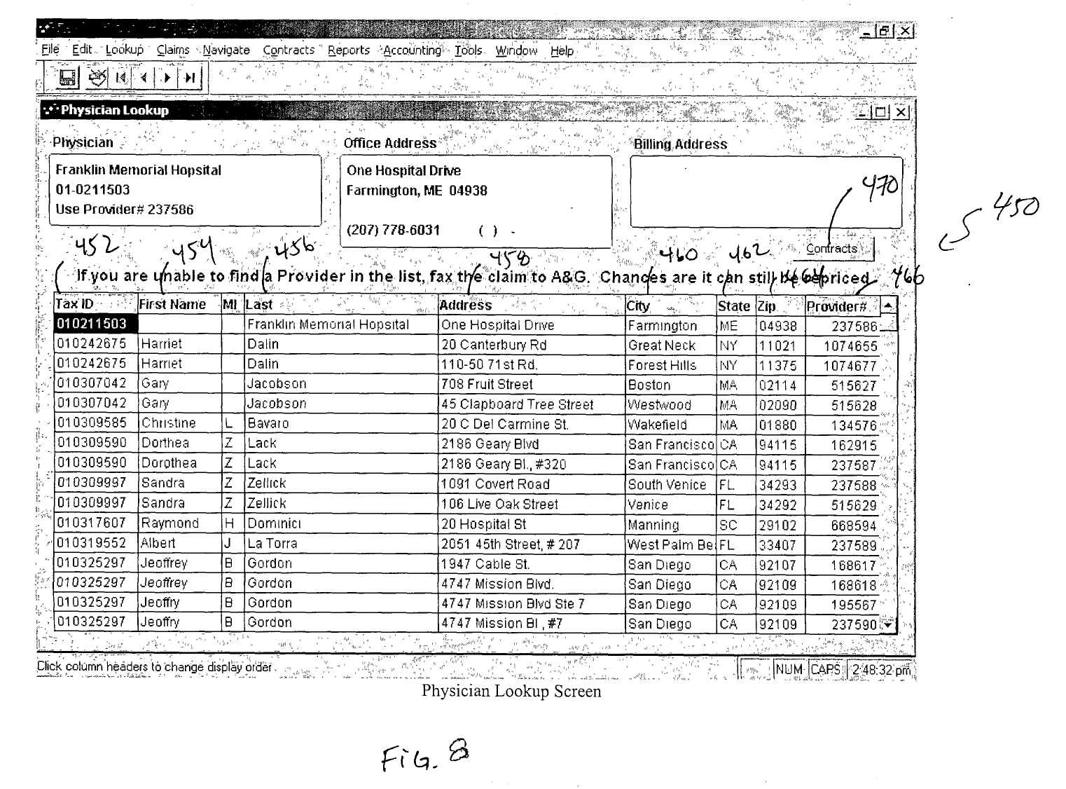

With reference now to FIG. 8, a physician lookup screen 450 is shown to include a plurality of healthcare provider information which can be stored in a provider records database, such as provider records database 266, in order to facilitate the lookup of a provider and his participation in one or more provider networks. As shown, each provider is listed with sufficient specific data, such as the tax id 452, first name 454, last name 456, address 458, city 460, state, 462, zip 464 and provider number 466, such that matching of an insured's claim with a specific physician is easily facilitated and, in most instances, assured to be accurate. Also shown in the physician lookup screen 450 is a contracts button 470, which gives the repricing operator access to contract details for the physician providers contained in the physician lookup screen 450.

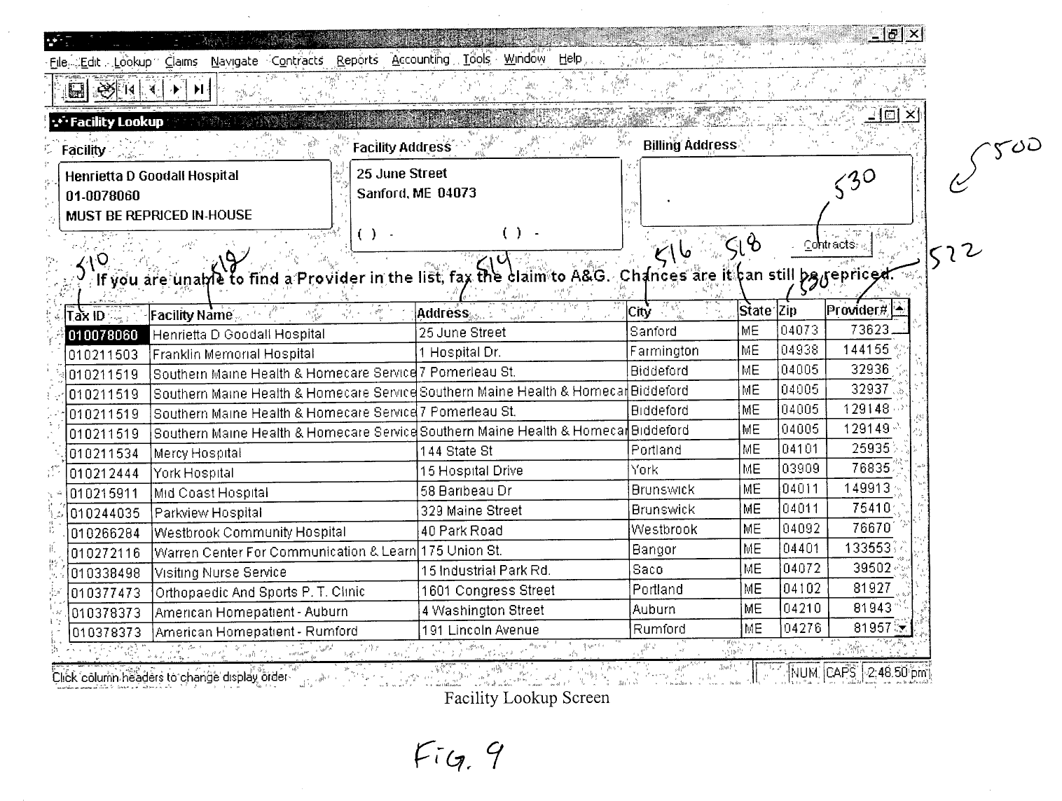

In addition, a repricing system according to the invention could provide a way of managing facilities which provide healthcare services under one or more insurance policies. As such, a facility lookup screen, such as facility lookup screen 500 of FIG. 9, provides the repricing operator with a way of managing facilities and entering data related to healthcare facilities. Like the physician lookup screen 450, the facility lookup screen 500 includes specific facility identifier information, such as the tax id 510, facility name 512, address 514, city 516, state 518, zip 520 and provider number 522. Likewise, a facility contracts button 530 is provided which allows entry of specific contract details between the facility and a PPO network that would dictate the terms of payment and amounts to be applied to various procedures.

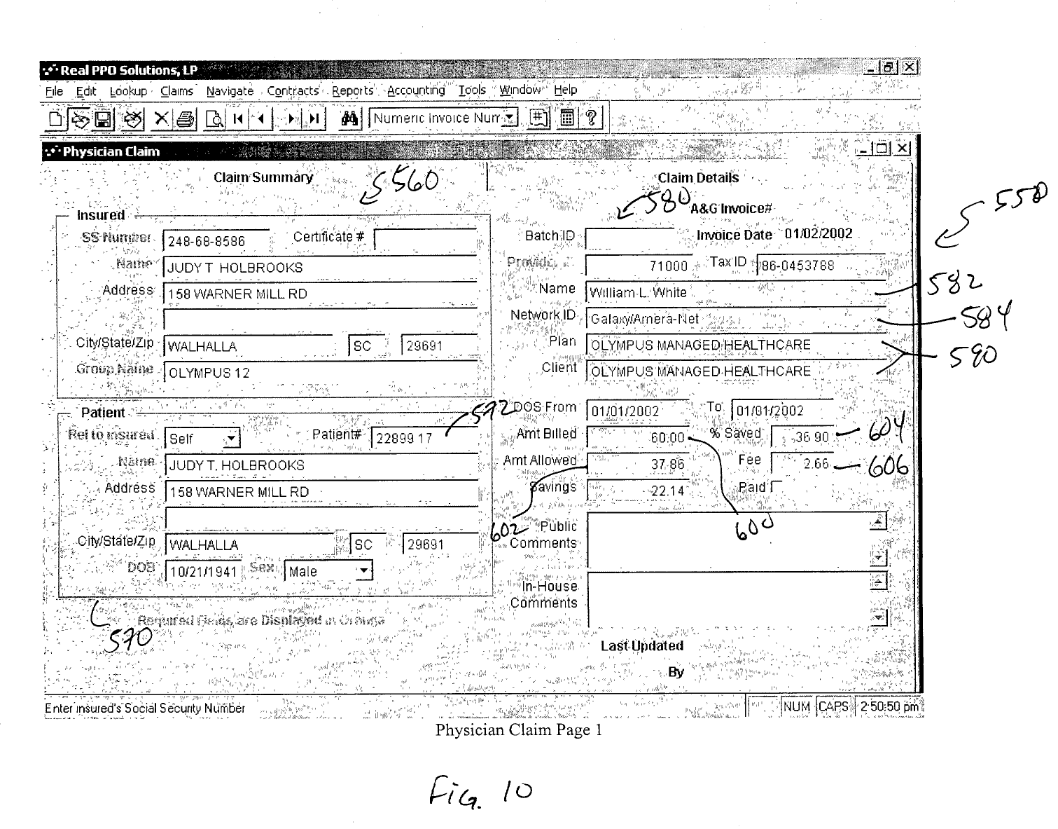

With reference to FIG. 10, therein is shown a claims page screen 550 which would contain the details of a claim submitted by a physician for payment in connection with services rendered to an insured. As shown, the physician claim includes a claim summary 560, with the insured's social security number, name, address, city and group name. A patient box 570 is also provided with a patient number field 572 that specifically identifies the patient who received the service. On the right-hand side of the physician claim page screen 550 is shown further claim details in the form of an invoice 580 which includes the name of the physician 582, the network to which the physician belongs 584 and the plan and client identifiers 590.

Next the physician claim page screen 550 shows the amount billed by the physician as well as the amount allowed 602 under the physician's contract with the provider network. Also indicated is the amount saved 604 by the insurance company as well as the fee charged by the repricing operator 606. In this way, the present invention provides a repricing system that is able to discount physician submitted claims according to pre-existing contracts between the provider network and the physician.

FIG. 11 shows a physician record page 650 with more details of a physician record. In particular, the physician record page 650 allows the repricing system to access contract details via the contract button 660. By depressing the contract button 660, the repricing operator is able to access the details shown in FIG. 12, which allows a plurality of contract details 670 to be entered by the repricing operator for a particular physician and a particular network to which the physician belongs.

Therefore, the methods and system of the present invention provide a way of discounting each procedure in a medical claim to the contractual amounts between a PPO and the facilities and physician members of the PPO. Typically, the PPO provides tabular data to the insurance company or third-party administrator that gives a list of CPT codes that the discounted values are based on, geographic fee schedules, and the demographics for each of their providers. A cross-reference is performed between a fee schedule table for a provider and the amounts allowed under the contract, such as the repricing system 200 is able to reprice a claim accurately and efficiently. Claim data can be entered into the system by an operator of the system and an output indicating the discounted amount for each procedure can be transmitted to the third-party administrator or insurance company which tells the party how much to pay the provider based on the service rendered. The provider may be part of a preferred provider network or a secondary network based on the insurance coverage particulars and the system is capable of picking a secondary network based on a predetermined list of secondary networks arranged according to a batting order.

In practice, the medical claims repricing system could be implemented with a terminal for entering and processing medical claims data and processing software operably associated with the terminal and adapted for receiving the medical claims data and automatically repricing a medical claim by comparing and validating the claim against a plurality of client, plan and group records. According to one embodiment, the processing software can be adapted to reprice a medical claim based on whether a claim is made within a primary or secondary network and, if in a secondary network, by accessing a secondary network database that stores a plurality of secondary network identifiers arranged according to a predetermined batting order.

While the invention has been described with respect to specific preferred embodiments, it should be understood that many variations and modifications will become apparent to those of ordinary skill in the art upon reference to the above. It is therefore intended that the dependent claims be interpreted as broadly as possible in view of the prior art to include all such variations and modifications.

What is claimed is:

1. A medical claims repricing system comprising:
a terminal for entering and processing medical claims data; and
processing software operably associated with the terminal and adapted for receiving the medical claims data and automatically repricing a medical claim by comparing and validating the claim against a plurality of client, plan and group records.

2. The system of claim 1 further comprising:
storage means within said terminal;
one or more databases stored on said storage means for storing the client, plan and group records.

3. The system of claim 1 wherein said processing software is further adapted to reprice a medical claim based on whether a claim is made within a primary or secondary network.

4. The system of claim 3 further comprising a secondary network database storing a plurality of secondary network identifiers arranged according to a predetermined batting order.

5. The system of claim 4 wherein the processing software is further adapted to reprice a medical claim made within a secondary network by checking the predetermined batting order.

6. The system of claim 2 wherein said one or more databases comprise a set of standardized medical procedures.

7. The system of claim 6 wherein said standardized medical procedures are identified in said one or more databases using common procedure terminology codes (CPT codes).

8. The system of claim 7 wherein said one or more databases comprise a list of physicians organized according to networks of physician service providers.

9. The system of claim 8 wherein said processing software is further adapted to cross-reference a medical claim against the CPT codes against a physician associated with the medical claim to determine a charge for the procedure or procedures specified in the medical claim.

10. The system of claim 9 wherein said one or more databases further comprise rate information for procedures associated with various CPT codes, the rate information reflecting any discounts for procedures based on physician and the physician's associated network.

11. The system of claim 10 wherein said processing software is further adapted to reprice a medical claim based on each procedure's CPT code and the rate information associated with the CPT code.

12. The system of claim 1 wherein said processing software is further adapted to verify that a physician associated with a medical claim is part of a specific network.

13. The system of claim 1 wherein said processing software is capable of repricing medical claims from a plurality of service provider networks.

14. The system of claim 1 wherein said processing software is further adapted to verify that an insured is covered by a particular plan of a particular service provider network.

15. The system of claim 1 wherein said processing software is further adapted to automatically cross-reference a plurality of insured claimants with the service provider network to which each claimant belongs.

16. The system of claim 15 wherein said processing software utilizes the social security number of each claimant to cross-reference to a claimant's service provider network.

17. The system of claim 1 wherein said processing software wherein said processing software is further adapted to reprice both in-network and out-of-network medical claims.

18. A method of repricing medical related claims submitted by insured claimants for services performed by any one of a plurality of service providers wherein the service providers are associated with one or more service provider networks, the method comprising the steps of:
medical claim data for a specified medical claim entered into a terminal adapted for receiving, storing and analyzing medical claim data; and
processing software within the terminal automatically repricing the medical claim by comparing and validating the medical claim data against a plurality of client, plan and group records, wherein repricing of a particular medical claim is done by cross-referencing any procedures performed by a physician against a plurality of common procedure terminology codes (CPT codes) and correlating the procedures against contract rules governing the charge for a procedure by a physician and a corresponding network of service providers.

19. The method of claim 18 further comprising the step of automatically verifying that an insured is covered by a contract associated with one of the network of service providers.

20. The method of claim 19 further comprising the step of determining if a medical claim is covered by a service provider in primary or secondary network.

21. The method of claim 20 further comprising the step of manually verifying a claim if it is not covered by a service provider in either a primary or secondary network.

22. The method of claim 20 further comprising the step of repricing the medical claim by checking a predetermined list of secondary networks.

23. The method of claim 18 further comprising the step of manually repricing a claim if automatic repricing is not available.

24. The method of claim 18 further comprising the step of the processing software creating a report of repriced medical claims.

25. The method of claim 19 further comprising the step of bundling all repriced medical claims for a single service provider or third party administrator into a single report.
